(19) United States
(12) Patent Application Publication
(10) Pub. No.: US 2012/0013305 A1
(43) Pub. Date: Jan. 19, 2012

(54) CHARGING/DISCHARGING DEVICE WITH LOW RESISTANCE CONDUCTOR SANDWICHED BETWEEN ELECTRODE PLATES

(76) Inventor: Tai-Her YANG, Dzan-Hwa (TW)

(21) Appl. No.: 12/834,974

(22) Filed: Jul. 13, 2010

(51) Int. Cl. H02J 7/04

(52) U.S. Cl. 320/134; 320/166

(57) ABSTRACT

The present invention relates to one or more electrode plates, which are installed with current collecting terminals at two or more sides thereof, sandwiching a low resistance conductor made of the material with conductivity better than that of the electrode plates; in which current collecting terminals are installed at two or more sides of the low resistance conductor, for connecting with the current collecting terminals installed at two or more sides of the electrode plates, and at least one of which are used to be the general current collecting terminal to output current to the external part or to receive the input current from the external part to constitute an electrode unit.

### BACKGROUND OF THE INVENTION

(a) Field of the Invention

The present invention relates to an electric charging/discharging device with low resistance conductor sandwiched between electrode plates, whose mainly structural figure is installed with low resistance conductors, wherein one or more electrode plates, which are installed with current collecting terminals at two or more sides thereof, clipping with an low resistance conductor, which is flat shape, strip, or mesh structure, and is made of the material and/or structure with conductivity better than that of the electrode plates; in which current collecting terminals are installed at two or more sides of the low resistance conductor, for unilateral or multilateral parallel linking with the current collecting terminals installed at two or more sides of the electrode plates, and which are used to be the general current collecting terminals to output current to the external part or to receive the input current from the external part; the number of the above general current collecting terminals for inputting/outputting the collection current is one or more.

(b) Description of the Prior Art

The conventional electric charging/discharging device, such as a variety of primary batteries, rechargeable batteries, capacitors, or super capacitors, whose electrode plate is usually installed with one or more current collecting terminals with same polarity at single side; FIG. 1 is a schematic view showing an embodiment of conventional electrode plate unilaterally installed with a current collecting terminal, in which each electrode plate (P100) is unilaterally installed with a current collecting terminal (T100) for the electrode plate performing the collecting current function of inputting/outputting current, or for connecting with another electrode plate in series or parallel; because the electrode plate is only unilaterally installed with a current collecting terminal for inputting/outputting current, the current density on the electrode plate is uneven at the electrode plate region of the neighboring current collecting terminal, another side of the electrode plate, and the electrode plate region more far away from the current collecting terminal (T100), when large current inputs or outputs; if two or more current collecting terminals are installed at same side of the electrode plate, which is more progressive, the electrode plate will have two or more pathways for inputting/outputting current, and two or more current collecting terminals with same polarity are linked in parallel through linking a conductor; but, this way only improves the uniformity of the input/output current density at same side, and it is useless to the uneven input/output current density at another side of the electrode plate.

In addition, one or more current collecting terminals, which are individually outward extended, are installed at two or more sides of the electrode plate for improvement; FIG. 2 is a schematic view showing an embodiment, in which the two sides of the electrode plate are individually installed with a current collecting terminal; or one or more sides of the electrode plate (P100) are installed with two or more current collecting terminals (T100) for forming two or more pathways for inputting/outputting current to reduce the resistance; FIG. 3 is a schematic view showing that two current collecting terminals are installed at each of the opposite sides of the electrode plate; although the ways shown in FIG. 2 and FIG. 3 improve the uniformity of the input/output current density, there is still inconvenient to use with input/output terminals installed at two sides.

### SUMMARY OF THE INVENTION

The present invention relates to an electric charging/discharging device with low resistance conductor sandwiched between electrode plates, which is applied to the desired positive and negative electrodes of electric charging/discharging devices such as primary batteries, secondary rechargeable batteries, capacitors, or super capacitors, or of fuel cells with electrode plates; the above device is installed with anode low resistance conductors, wherein one or more anode electrode plates, which are installed with at least one current collecting terminals at each of two or more sides thereof, sandwich an anode low resistance conductor, which is flat shape, strip, or mesh structure, and is made of the material and/or structure with conductivity better than that of the electrode plates; in which at least one current collecting terminals are installed at each of two or more sides of the anode low resistance conductor, for unilateral or multilateral parallel connecting with the current collecting terminals installed at two or more sides of the anode electrode plates, and which are used to be the anode general current collecting terminals to output current to the external part or to receive the input current from the external part; the number of the above anode general current collecting terminals for inputting/outputting the collection current is one or more.

Also, the above device is installed with cathode low resistance conductors, wherein one or more cathode electrode plates, which are installed with at least one current collecting terminals at each of two or more sides thereof, sandwich an cathode low resistance conductor, which is flat shape, strip, or mesh structure, and is made of the material and/or structure with conductivity better than that of the electrode plates; in which at least one current collecting terminals are installed at each of two or more sides of the cathode low resistance conductor, for unilateral or multilateral parallel connecting with the current collecting terminals installed at two or more sides of the cathode electrode plates, and which are used to be the cathode general current collecting terminals to output current to the external part or to receive the input current from the external part; the number of the above cathode general current collecting terminals for inputting/outputting the collection current is one or more.

### BRIEF DESCRIPTION OF THE DRAWINGS

FIG. 1 is a schematic view showing an embodiment of conventional electrode plate unilaterally installed with a current collecting terminal;

FIG. 2 is a schematic view showing an embodiment of conventional electrode plate installed with a current collecting terminal at each of two sides;

FIG. 3 is a schematic view showing an embodiment of conventional electrode plate installed with two current collecting terminals at each of the opposite sides;

FIG. 4 is a schematic view showing the three-dimensional structure of present invention, which is constituted by the low resistance conductor with at least one current collecting terminal installed at each of at least two sides thereof, and two electrode plates with same polarity with at least one current collecting terminal installed at each of at least two sides thereof sandwich at two laterals of the low resistance conductor;

FIG. 5 is a front view of FIG. 4;

FIG. 6 is a side view of FIG. 4;

FIG. 7 is a schematic decomposition view of an embodiment, in which the electrode pair of an electric charging/discharging device is constituted by two anode electrode plates 1011 sandwiching an anode low resistance conductor 1001 and two cathode electrode plates 1012 sandwiching a cathode low resistance conductor 1002;

FIG. 8 is a schematic view showing an embodiment of combination of the electrode pair constituting the electric charging/discharging device shown in FIG. 7;

FIG. 9 is a schematic view showing the electric charging/discharging device constituted by the electrode pair shown in FIG. 8 and the current paths thereof;

FIG. 10 is a schematic view showing an embodiment of combination of two negative electrode units sandwiching a positive electrode unit at two laterals thereof, according to the present invention;

FIG. 11 is a schematic view showing an embodiment of combination of two positive electrode units sandwiching a negative electrode unit at two laterals thereof, according to the present invention;

FIG. 12 is a schematic view showing the second embodiment of combination of two negative electrode units sandwiching a positive electrode unit at two laterals thereof, according to the present invention;

FIG. 13 is a schematic view showing the second embodiment of combination of two positive electrode units sandwiching a negative electrode unit at two laterals thereof, according to the present invention;

FIG. 14 is a schematic view showing an embodiment of further combination of at least two negative electrode units and at least two positive electrode units staggered placed for unilateral or bilateral parallel connecting the same polarity ones in a common electrode tank, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current, according to the present invention;

FIG. 15 is a schematic view showing the second embodiment of combination of electrode units with same polarity for unilateral or bilateral parallel connection in a common electrode tank, in which the anode input/output general current collecting terminal 1051 of the positive electrode unit and the cathode input/output general current collecting terminal 1052 of the negative electrode unit, placed at two laterals, are used to be the general current collecting terminals for inputting/outputting current, according to the present invention;

FIG. 16 is a schematic view showing the third embodiment of combination of at least two negative electrode units and at least two positive electrode units staggered placed, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current, according to the present invention;

FIG. 17 is a three-dimensional schematic view showing the decomposition structure of FIG. 16;

FIG. 18 is a three-dimensional schematic view showing the combination structure of FIG. 16;

FIG. 19 is a schematic view showing an embodiment of combination of electrode pairs constituted by positive and negative electrodes for staggered parallel superposition, in which the positive-negative electrode pair is sandwiched therein, according to the present invention;

FIG. 20 is a schematic view showing the second embodiment of combination of negative electrode units and positive electrode units for staggered placement, in which the anode input/output general current collecting terminal 1051 of the positive electrode unit and the cathode input/output general current collecting terminal 1052 of the negative electrode unit, placed at two laterals, are used to be the general current collecting terminals for inputting/outputting current;

FIG. 21 is a schematic view showing the third embodiment of combination of negative electrode units and positive electrode units for staggered placement, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current;

FIG. 22 is a schematic view showing the combination of the electrode pair constituted by at least one positive electrode unit and at least one negative electrode unit, in which the polarities of two laterals, the monolithic positive polarity electrode plate, and the monolithic negative polarity electrode plate are staggered superposition, and the anode input/output general current collecting terminal 1051 of the positive electrode unit and the cathode input/output general current collecting terminal 1052 of the negative electrode unit, placed at intermediate portion, are used to be the general current collecting terminals for inputting/outputting current;

FIG. 23 is a schematic view showing an embodiment of combination, in which a number of electrode pairs constituted by positive-negative electrode units placed in individual electrode tank 1030 are unilateral or multilateral connected in series by different polarity;

FIG. 24 is a schematic view showing the second embodiment of combination shown in FIG. 23, in which except for the anode input/output general current collecting terminal and the cathode input/output general current collecting terminal, which are used to input/output current, are exposed to the outside of the tank shell of the electrode tank 1030, the other current collecting terminals are hidden within the electrode tank 1030;

FIG. 25 is a schematic view showing an embodiment of combination, in which a number of electrode pairs constituted by positive-negative electrode units placed at individual electrode tank 1030 are unilateral or multilateral connected in series by different polarity;

FIG. 26 is a schematic view showing the second embodiment of combination shown in FIG. 25, in which except for the current terminals, which are used to input/output current, are exposed to the outside of the tank shell, the other current collecting terminals are hidden within the electrode tank 1030;

FIG. 27 is a three-dimensional structural schematic view showing the electrode unit constituted by the low resistance conductor, in which two input/output current collecting terminals are installed at each of two sides thereof, clipped by the electrode plate(s) with same polarity, in which two current collecting terminals are installed at each of two sides thereof, at one of two or two outer sides of the low resistance conductor, according to the present invention;

FIG. 28 is a front view of FIG. 27;

FIG. 29 is a side view of FIG. 27;

FIG. 30 is a three-dimensional structural schematic view showing the electrode unit constituted by the low resistance conductor, in which a current collecting terminal is installed at each of four sides thereof, clipped by the electrode plate(s) with same polarity, in which a current collecting terminal is installed at each of four sides thereof, at one of two or two outer sides of the low resistance conductor, according to the present invention;

FIG. 31 is a front view of FIG. 30;

FIG. 32 is a side view of FIG. 30;

FIG. 33 is a three-dimensional structural schematic view showing the electrode unit constituted by the low resistance conductor, in which two current collecting terminals are installed at each of four sides thereof, clipped by the electrode plate(s) with same polarity, in which two current collecting terminals are installed at each of four sides thereof, at one of two or two outer sides of the low resistance conductor, according to the present invention;

FIG. 34 is a front view of FIG. 33;

FIG. 35 is a side view of FIG. 33;

FIG. 36 is a schematic structural view showing an embodiment of application, in which the conductor is radial and the electrode unit is grid layout, according to the present invention;

FIG. 37 is a front view of FIG. 36;

FIG. 38 is a side view of FIG. 36;

FIG. 39 is a schematic structural view showing an embodiment of application, in which the electrode unit is plate type, according to the present invention;

FIG. 40 is a front view of FIG. 39;

FIG. 41 is a side view of FIG. 39;

FIG. 42 is a schematic view showing an embodiment of application, in which the electrode unit is used to be a winding type electric charging/discharging device, according to the present invention;

FIG. 43 is a top view of FIG. 42; and

FIG. 44 is a side view of FIG. 42.

### DESCRIPTION OF MAIN COMPONENT SYMBOLS

P100: Electrode plate
T100: Current collecting terminal
100: Low resistance conductor
101: Side electrode plate
104: Current collecting terminal
105: Input/output general current collecting terminal
120: Active substance
601: Current collecting terminal of the monolithic anode electrode plate 1031
602: Current collecting terminal of the monolithic cathode electrode plate 1032
1001: Anode low resistance conductor
1002: Cathode low resistance conductor
1011: Anode side electrode plate
1012: Cathode side electrode plate
1020: Isolated body
1030: Electrode tank
1031: Monolithic anode electrode plate
1032: Monolithic cathode electrode plate
1041: Anode current collecting terminal
1042: Cathode current collecting terminal
1051: Anode input/output general current collecting terminal
1052: Cathode input/output general current collecting terminal

### DETAILED DESCRIPTION OF THE PREFERRED EMBODIMENTS

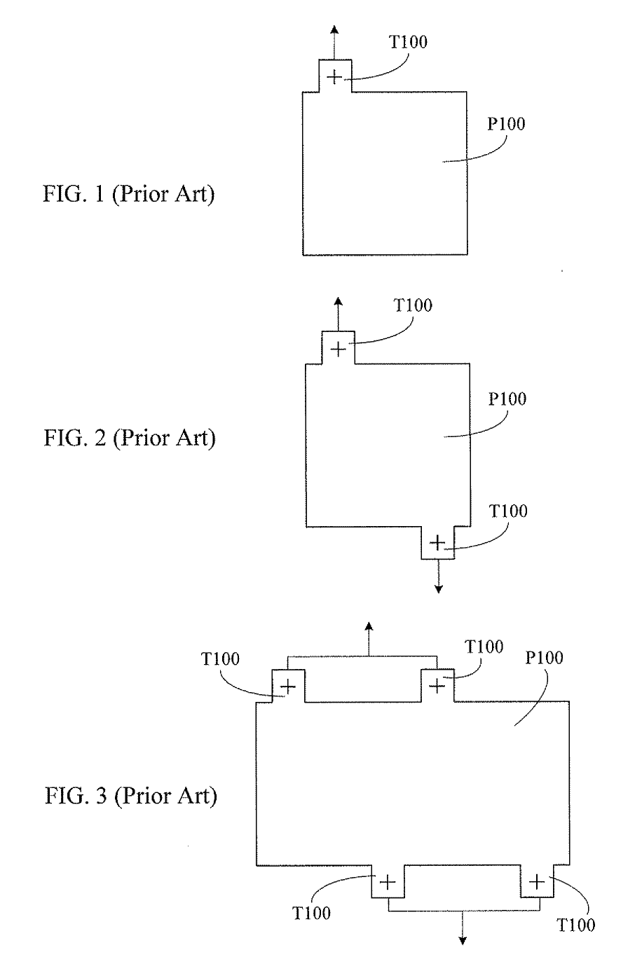

The conventional electric charging/discharging device, such as a variety of primary batteries, rechargeable batteries, capacitors, or super capacitors, whose electrode plate is usually installed with one or more current collecting terminals with same polarity at single side; FIG. 1 is a schematic view showing an embodiment of conventional electrode plate unilaterally installed with a current collecting terminal, in which each electrode plate (P100) is unilaterally installed with a current collecting terminal (T100) for the electrode plate performing the collecting current function of inputting/outputting current, or for connecting with another electrode plate in series or parallel; because the electrode plate is only unilaterally installed with a current collecting terminal for inputting/outputting current, the current density on the electrode plate is uneven at the electrode plate region of the neighboring current collecting terminal, another side of the electrode plate, and the electrode plate region more far away from the current collecting terminal (T100), when large current inputs or outputs; if two or more current collecting terminals are installed at same side of the electrode plate, which is more progressive, the electrode plate will have two or more pathways for inputting/outputting current, and two or more current collecting terminals with same polarity are linked in parallel through linking a conductor; but, this way only improves the uniformity of the input/output current density at same side, and it is useless to the uneven input/output current density at another side of the electrode plate.

In addition, one or more current collecting terminals, which are individually outward extended, are installed at two or more sides of the electrode plate for improvement; FIG. 2 is a schematic view showing an embodiment, in which the two sides of the electrode plate are individually installed with a current collecting terminal; or one or more sides of the electrode plate P100 are installed with two or more current collecting terminals T100 for forming two or more pathways for inputting/outputting current to reduce the resistance; FIG. 3 is a schematic view showing that two current collecting terminals are installed at each of the opposite sides of the electrode plate; although the ways shown in FIG. 2 and FIG. 3 improve the uniformity of the input/output current density, there is still inconvenient to use with input/output terminals installed at two sides.

The present invention relates to an electric charging/discharging device with low resistance conductor sandwiched between electrode plates, whose mainly structural figure is installed with low resistance conductors, wherein one or more electrode plates, which are installed with at least one current collecting terminal at each of two or more sides thereof, sandwich an low resistance conductor, which is flat shape, strip, or mesh structure, and is made of the material and/or structure with conductivity better than that of the electrode plates; in which at least one current collecting terminal is installed at each of two or more sides of the low resistance conductor, for unilateral or multilateral parallel connecting with the current collecting terminals installed at two or more sides of the electrode plates, and which are used to be the general current collecting terminals to output current to the external part or to receive the input current from the external part; the number of the above general current collecting terminals for inputting/outputting the collection current is one or more.

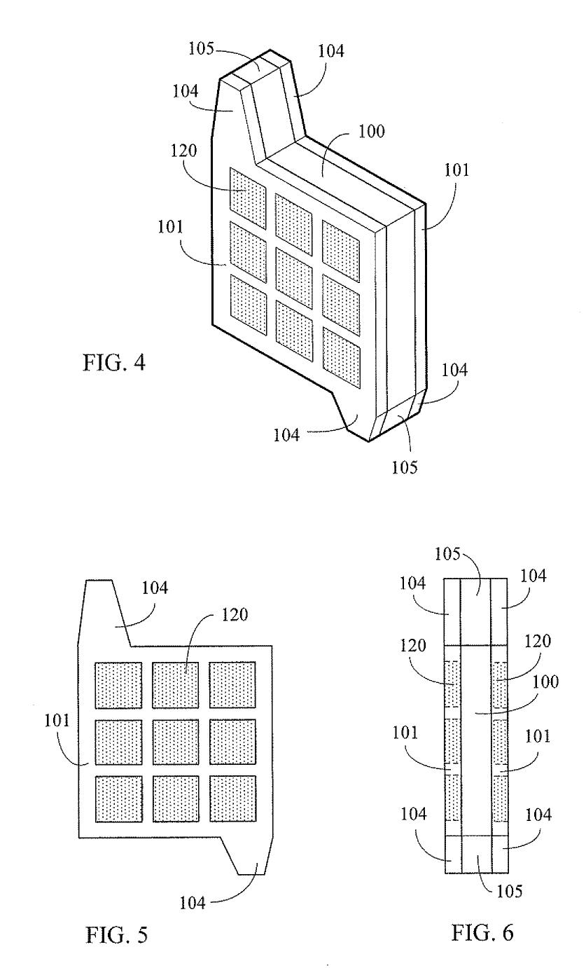

FIG. 4 is a schematic view showing the three-dimensional structure of present invention, which is constituted by the low resistance conductor with at least one current collecting terminal installed at each of at least two sides thereof, and two electrode plates with same polarity with at least one current collecting terminal installed at each of at least two sides thereof sandwich at two laterals of the low resistance conductor.

FIG. 5 is a front view of FIG. 4.

FIG. 6 is a side view of FIG. 4.

As shown in FIG. 4, FIG. 5, and FIG. 6, the mainly structural figure is installed with a low resistance conductor 100, wherein one or more side electrode plates 101, which are installed with at least one current collecting terminal 104 at two or more sides thereof, and coated with active substance 120 on the surface of the electrode plate, sandwich the low resistance conductor 100, which is flat shape, strip, or mesh structure, and is made of the material and/or structure with conductivity better than that of the electrode plates; in which at least one input/output general current collecting terminal 105 is installed at each of two or more sides of the low resistance conductor 100, for unilateral or multilateral parallel connecting with the current collecting terminals installed at two or more sides of the side electrode plates, and which are used to be the general current collecting terminals to output current to the external part or to receive the input current from the external part, therefore to constitute an electrode unit; the number of the general current collecting terminals 105 for inputting/outputting the collection current is one or more.

For the electric charging/discharging device with low resistance conductor sandwiched between electrode plates, which is applied to the electric charging/discharging device, such as primary batteries, rechargeable batteries, capacitors, or super capacitors, or to the positive-negative electrode pair required for the fuel cell with electrode plate(s).

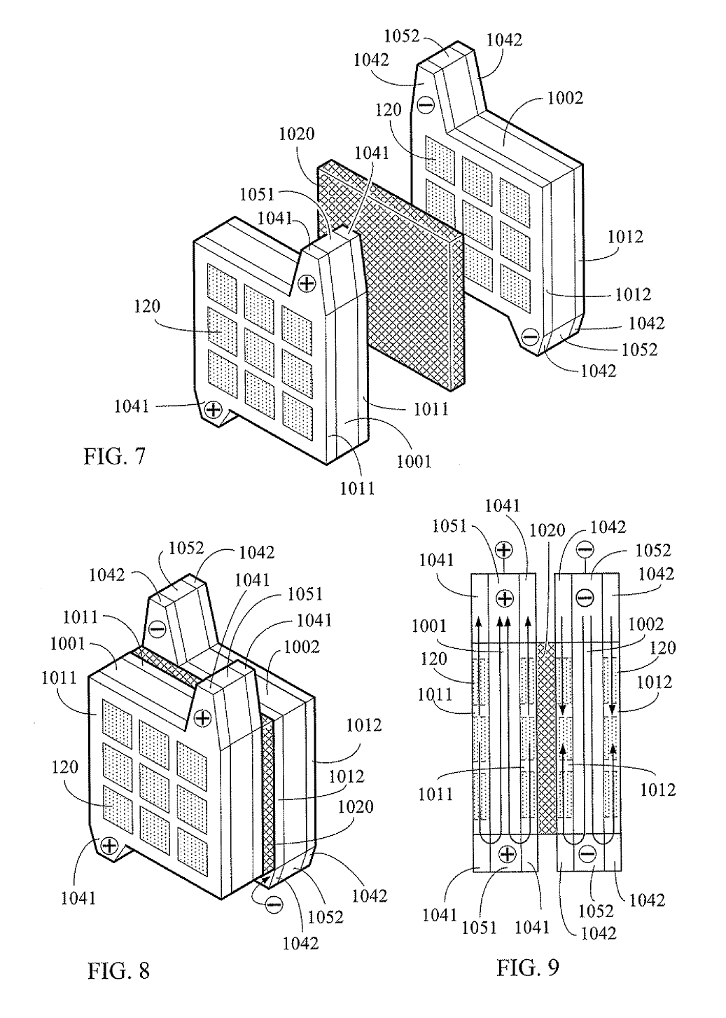

FIG. 7 is a schematic decomposition view of an embodiment, in which the electrode pair of an electric charging/discharging device is constituted by two anode electrode plates 1011 sandwiching an anode low resistance conductor 1001 and two cathode electrode plates 1012 sandwiching a cathode low resistance conductor 1002.

FIG. 8 is a schematic view showing an embodiment of combination of the electrode pair constituting the electric charging/discharging device shown in FIG. 7.

FIG. 9 is a schematic view showing the electric charging/discharging device constituted by the electrode pair shown in FIG. 8 and the current paths thereof.

As shown in FIG. 7, FIG. 8, and FIG. 9, the mainly structural figure is installed with an anode low resistance conductor 1001, wherein one or more anode side electrode plates 1011, which are installed with at least one anode current collecting terminal 1041 at two or more sides thereof, and coated with the active substance 120 on the surface of the electrode plate, sandwich the anode low resistance conductor 1001, which is flat shape, strip, or mesh structure, and is made of the material and/or structure with conductivity better than that of the electrode plates; in which at least one anode input/output general current collecting terminal 1051 is installed at each of two or more sides of the anode low resistance conductor 1001, for unilateral or multilateral parallel connecting with the anode current collecting terminals installed at two or more sides of the anode side electrode plates, and which are used to be the anode general current collecting terminals to output current to the external part or to receive the input current from the external part, therefore to constitute a positive electrode unit; the number of the anode input/output general current collecting terminal 1051 for inputting/outputting the collection current is one or more.

Also, a cathode low resistance conductor 1002 is installed, wherein one or more cathode side electrode plate 1012, which are installed with at least one cathode current collecting terminal 1042 at two or more sides thereof, and coated with the active substance 120 on the surface of the electrode plate, sandwich the cathode low resistance conductor 1002, which is flat shape, strip, or mesh structure, and is made of the material and/or structure with conductivity better than that of the electrode plates; in which at least one cathode input/output general current collecting terminal 1052 is installed at each of two or more sides of the cathode low resistance conductor 1002, for unilateral or multilateral parallel connecting with the cathode current collecting terminals installed at two or more sides of the cathode side electrode plates, and which are used to be the cathode general current collecting terminals to output current to the external part or to receive the input current from the external part, therefore to constitute a negative electrode unit; the number of the cathode input/output general current collecting terminal 1052 for inputting/outputting the collection current is one or more.

The positive electrode unit and the negative electrode unit mentioned above are installed in a common electrode tank for constituting the electrode pair after combination.

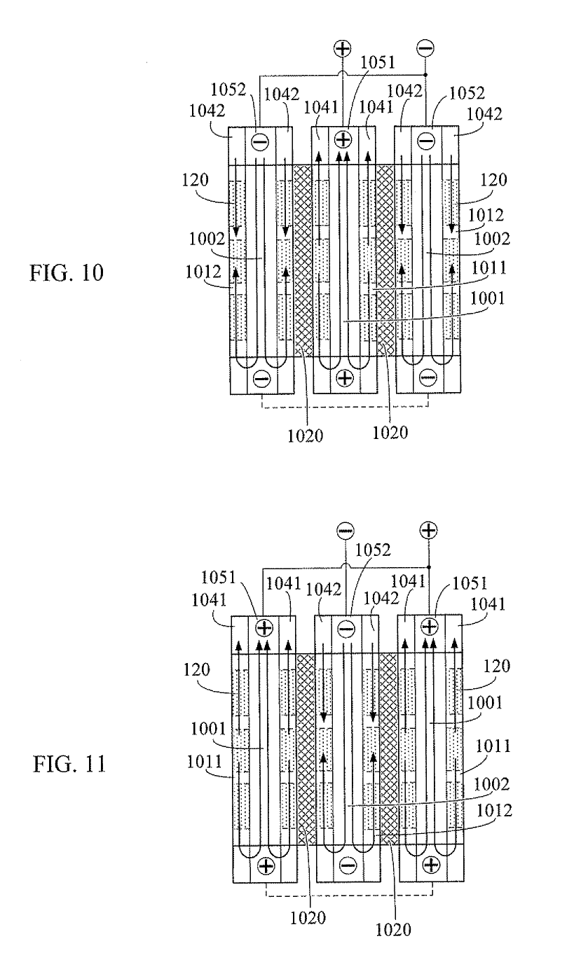

FIG. 10 is a schematic view showing an embodiment of combination of two negative electrode units sandwiching a positive electrode unit at two laterals thereof, according to the present invention; in which:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit; and
the positive electrode unit is constituted by two anode side electrode plates 1011 coated with the active substance 120 on the surface of each electrode plate sandwiching the anode low resistance conductor 1001 at two laterals thereof; the anode current collecting terminal 1041 placed at two sides of each of two anode side electrode plates 1011 connect with the anode input/output general current collecting terminals 1051 placed at two sides of the anode low resistance conductor 1001 to constitute the positive electrode unit; the cathode input/output general current collecting terminals 1052 of the two negative electrode units are installed at two sides of the positive electrode unit for unilateral or multilateral parallel connection; and isolated bodies 1020 are installed between the two sides of the positive electrode unit and the two negative electrode units, respectively.

The positive electrode unit and the negative electrode unit mentioned above are installed in a common electrode tank for constituting the electrode pair after combination.

FIG. 11 is a schematic view showing an embodiment of combination of two positive electrode units sandwiching a negative electrode unit at two laterals thereof, according to the present invention; in which:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plate sandwiching the anode low resistance conductor 1001 at two laterals thereof; the anode current collecting terminal 1041 placed at two sides of each of two anode side electrode plates 1011 connect with the anode input/output general current collecting terminals 1051 placed at two sides of the anode low resistance conductor 1001 to constitute the positive electrode unit; and
the anode input/output general current collecting terminals 1051 of the two positive electrode units installed at two sides of the negative electrode unit are in unilateral or multilateral parallel connection; and isolated bodies 1020 are installed between the two sides of the negative electrode unit and the two positive electrode units, respectively.

The positive electrode unit and the negative electrode unit mentioned above are installed in a common electrode tank for constituting the electrode pair after combination.

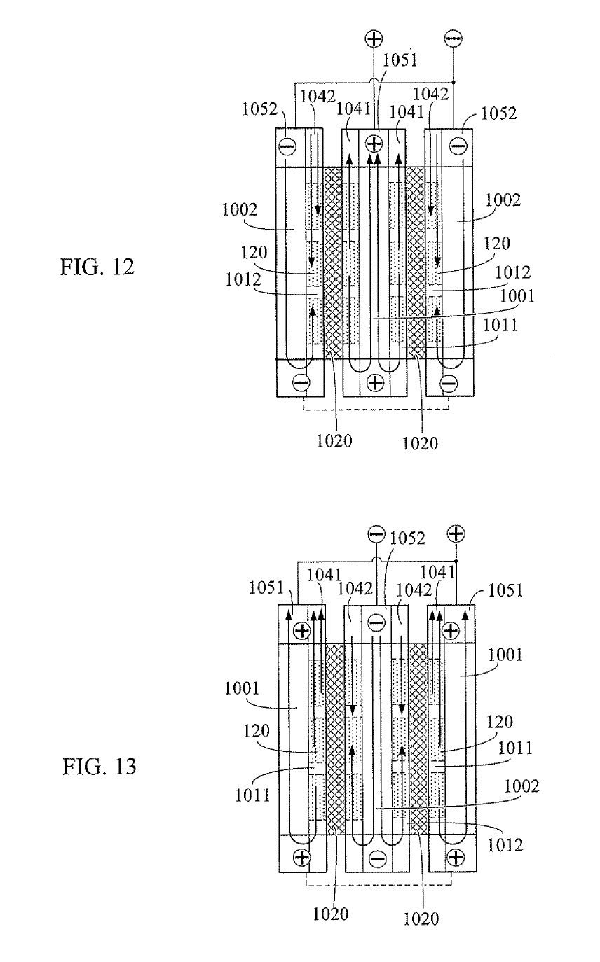

FIG. 12 is a schematic view showing the second embodiment of combination of two negative electrode units sandwiching a positive electrode unit at two laterals thereof, according to the present invention; in which:
the negative electrode unit is constituted by one cathode side electrode plate 1012 coated with the active substance 120 on the surface of the electrode plate clipping with the cathode low resistance conductor 1002 at one lateral thereof; the cathode current collecting terminals 1042 placed at two sides of the cathode side electrode plate 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plate sandwiching the anode low resistance conductor 1001 at two laterals thereof; the anode current collecting terminal 1041 placed at two sides of each of two anode side electrode plates 1011 connect with the anode input/output general current collecting terminals 1051 placed at two sides of the anode low resistance conductor 1001 to constitute the positive electrode unit; and
the cathode input/output general current collecting terminals 1052 of the two negative electrode units installed at two sides of the positive electrode unit are in unilateral or multilateral parallel connection; and isolated bodies 1020 are installed between the two sides of the positive electrode unit and the two negative electrode units, respectively.

The positive electrode unit and the negative electrode unit mentioned above are installed in a common electrode tank for constituting the electrode pair after combination.

FIG. 13 is a schematic view showing the second embodiment of combination of two positive electrode units sandwiching a negative electrode unit at two laterals thereof, according to the present invention; in which:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by one anode side electrode plate 1011 coated with the active substance 120 on the surface of the electrode plate clipping with the anode low resistance conductor 1001 at one lateral thereof; the anode current collecting terminal 1041 placed at two sides of the anode side electrode plates 1011 connect with the anode input/output general current collecting terminals 1051 placed at two sides of the anode low resistance conductor 1001 to constitute the positive electrode unit; and
the anode input/output general current collecting terminals 1051 of the two positive electrode units installed at two sides of the negative electrode unit are in unilateral or multilateral parallel connection; and isolated bodies 1020 are installed between the two sides of the negative electrode unit and the two positive electrode units, respectively.

The positive electrode unit and the negative electrode unit mentioned above are installed in a common electrode tank for constituting the electrode pair after combination.

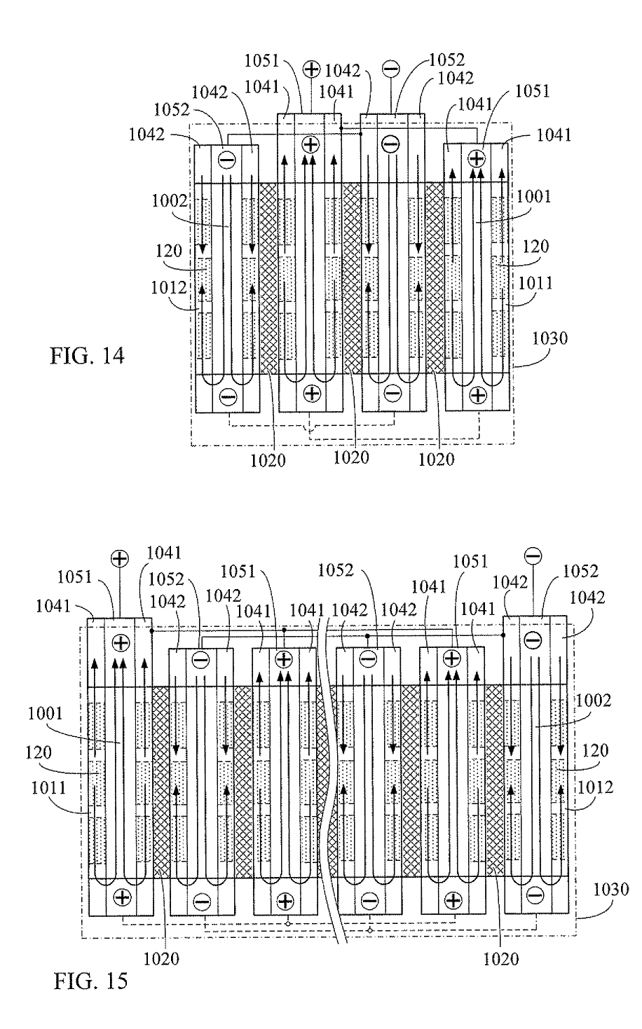

FIG. 14 is a schematic view showing an embodiment of further combination of at least two negative electrode units and at least two positive electrode units staggered placed for unilateral or bilateral parallel connecting the same polarity ones in a common electrode tank, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current, according to the present invention; in which
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plates sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least two negative electrode units and at least two positive electrode units are staggered placed in an electrode tank 1030, in which: the anode input/output general current collecting terminals 1051 of the positive electrode units are used for unilateral or bilateral parallel connecting the same polarity ones, the cathode input/output general current collecting terminals 1052 of the negative electrode units are used for unilateral or bilateral parallel connecting the same polarity ones, and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

FIG. 15 is a schematic view showing the second embodiment of combination of electrode units with same polarity for unilateral or bilateral parallel connection in a common electrode tank, in which the anode input/output general current collecting terminal 1051 of the positive electrode unit and the cathode input/output general current collecting terminal 1052 of the negative electrode unit, placed at two laterals, are used to be the general current collecting terminals for inputting/outputting current, according to the present invention; in which: at least two negative electrode units and at least two positive electrode units are staggered placed;
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plates sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least two negative electrode units and at least two positive electrode units are staggered placed in the electrode tank 1030, in which: the anode input/output general current collecting terminals 1051 of the positive electrode units are used for unilateral or bilateral parallel connecting the same polarity ones, the cathode input/output general current collecting terminals 1052 of the negative electrode units are used for unilateral or bilateral parallel connecting the same polarity ones, and the anode input/output general current collecting terminal 1051 of the positive electrode unit and the cathode input/output general current collecting terminal 1052 of the negative electrode unit, placed at two laterals, are used to be the general current collecting terminals for the anodes and cathodes inputting/outputting current.

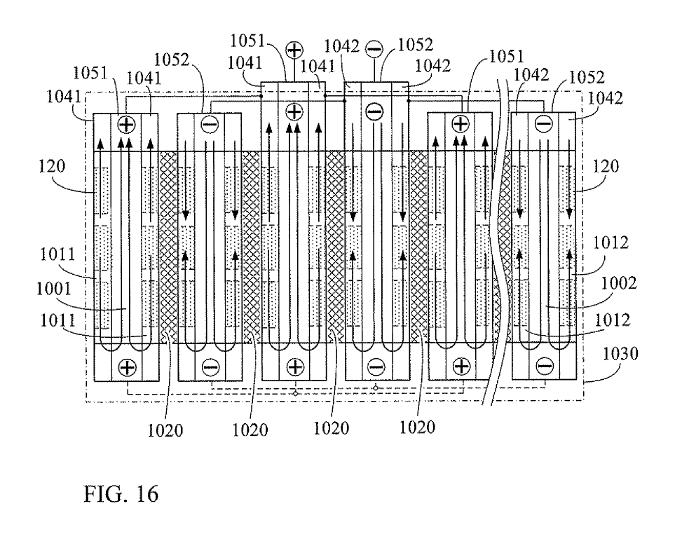

FIG. 16 is a schematic view showing the third embodiment of combination of at least two negative electrode units and at least two positive electrode units staggered placed, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current, according to the present invention; in which:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plates sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least two negative electrode units and at least two positive electrode units are staggered placed in the electrode tank 1030, in which: the anode input/output general current collecting terminals 1051 of the positive electrode units are used for unilateral or bilateral parallel connecting the same polarity ones, the cathode input/output general current collecting terminals 1052 of the negative electrode units are used for unilateral or bilateral parallel connecting the same polarity ones, and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

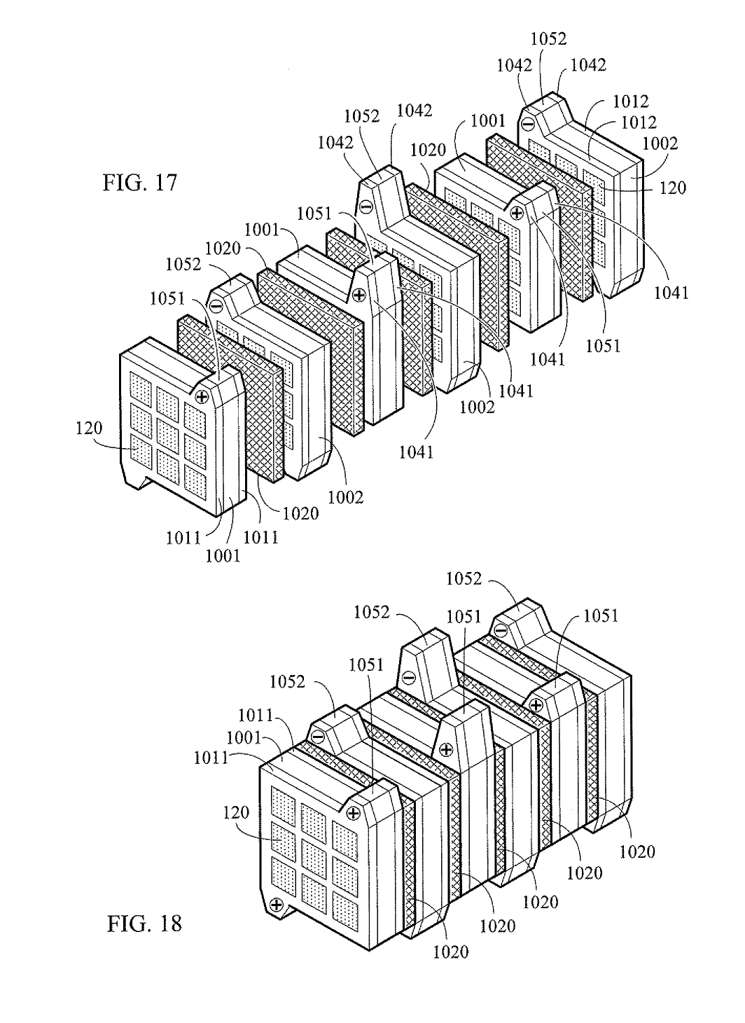

FIG. 17 is a three-dimensional schematic view showing the decomposition structure of FIG. 16.

FIG. 18 is a three-dimensional schematic view showing the combination structure of FIG. 16.

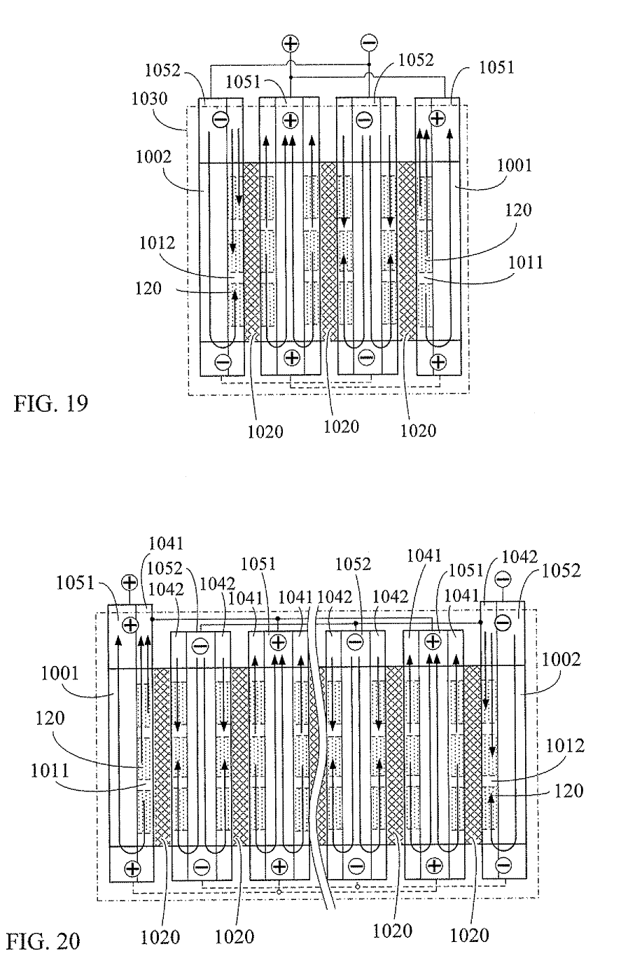

Another structural mode of the present invention is shown as FIG. 19, which is a schematic view showing an embodiment of combination of electrode pairs constituted by positive and negative electrodes for staggered parallel superposition, in which the positive-negative electrode pair with input/output general current collecting terminals is sandwiched therein, according to the present invention; in which, the positive electrode unit placed at one lateral is constituted by the anode low resistance conductor 1001 placed at lateral clipping with the anode side electrode plate 1011 coated with the active substance 120 on the surface of the electrode plate at the intermediate section thereof, and the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit at lateral;
the negative electrode unit placed at another lateral is constituted by the cathode low resistance conductor 1002 placed at lateral clipping with the cathode side electrode plate 1012 coated with the active substance 120 on the surface of the electrode plate at the intermediate section thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit at lateral; and
two cathode side electrode plates 1012 are coated with the active substance 120 on each electrode plate and sandwiching the cathode low resistance conductor 1002 at two laterals thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit; and
two anode side electrode plates 1011 are coated with the active substance 120 on each electrode plate and sandwiching the anode low resistance conductor 1001 at two laterals thereof, and the anode current collecting terminals 1041 placed at two sides of each of two anode side electrode plate1 1011 connect with the anode input/output general current collecting terminals 1051 placed at two sides of the anode low resistance conductor 1001 to constitute the positive electrode unit; and
the above negative electrode units and positive electrode units are staggered placement for constituting the electrode pairs, the negative electrode unit and the positive electrode unit, placed at two laterals, are placed in the electrode tank 1030, and the isolated body 1020 is installed between the positive and negative electrode units, which are staggered placement, in which: the anode input/output general current collecting terminal 1051 of each positive electrode unit is unilateral or multilateral connected with same polarity, the cathode input/output general current collecting terminal 1052 of each negative electrode unit is unilateral or multilateral connected with same polarity, and the anode input/output general current collecting terminal 1051 of the positive electrode unit and the cathode input/output general current collecting terminal 1052 of the negative electrode unit, placed at intermediate portion, are used to be the general current collecting terminals for inputting/outputting current.

Another structural mode of the present invention is shown as FIG. 20, which is a schematic view showing the second embodiment of combination of negative electrode units and positive electrode units for staggered placement, in which the anode input/output general current collecting terminal 1051 of the positive electrode unit and the cathode input/output general current collecting terminal 1052 of the negative electrode unit, placed at two laterals, are used to be the general current collecting terminals for inputting/outputting current; in which, the positive electrode unit placed at lateral is constituted by the anode low resistance conductor 1001 placed at lateral clipping with the anode side electrode plate 1011 coated with the active substance 120 on the surface of the electrode plate at the intermediate section thereof, and the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit at lateral;
the negative electrode unit placed at another lateral is constituted by the cathode low resistance conductor 1002 placed at lateral clipping with the cathode side electrode plate 1012 coated with the active substance 120 on the surface of the electrode plate at the intermediate section thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit at lateral;
two cathode side electrode plates 1012 are coated with the active substance 120 on each electrode plate and at the intermediate section of the side electrode plates 1012 sandwiching the cathode low resistance conductor 1002 at two laterals thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
two anode side electrode plates 1011 are coated with the active substance 120 on each electrode plate and at the intermediate section of the side electrode plates 1011 sandwiching the anode low resistance conductor 1001 at two laterals thereof, and the anode current collecting terminals 1041 placed at two sides of each of two anode side electrode plate1 1011 connect with the anode input/output general current collecting terminals 1051 placed at two sides of the anode low resistance conductor 1001 to constitute the positive electrode unit; and
the above negative electrode units and positive electrode units are staggered placement for constituting the electrode pairs, the negative electrode unit and the positive electrode unit, placed at two laterals, are placed in the electrode tank 1030, and the isolated body 1020 is installed between the positive and negative electrode units, which are staggered placement, in which: the anode input/output general current collecting terminals 1051 placed at two sides of each positive electrode unit coated with the active substance 120 on the electrode plate are unilateral or multilateral connected with same polarity, the cathode input/output general current collecting terminals 1052 placed at two sides of each negative electrode unit are unilateral or multilateral connected with same polarity, and the anode input/output general current collecting terminal 1051 of the positive electrode unit and the cathode input/output general current collecting terminal 1052 of the negative electrode unit, placed at two laterals, are used to be the general current collecting terminals for the anodes and cathodes inputting/outputting current.

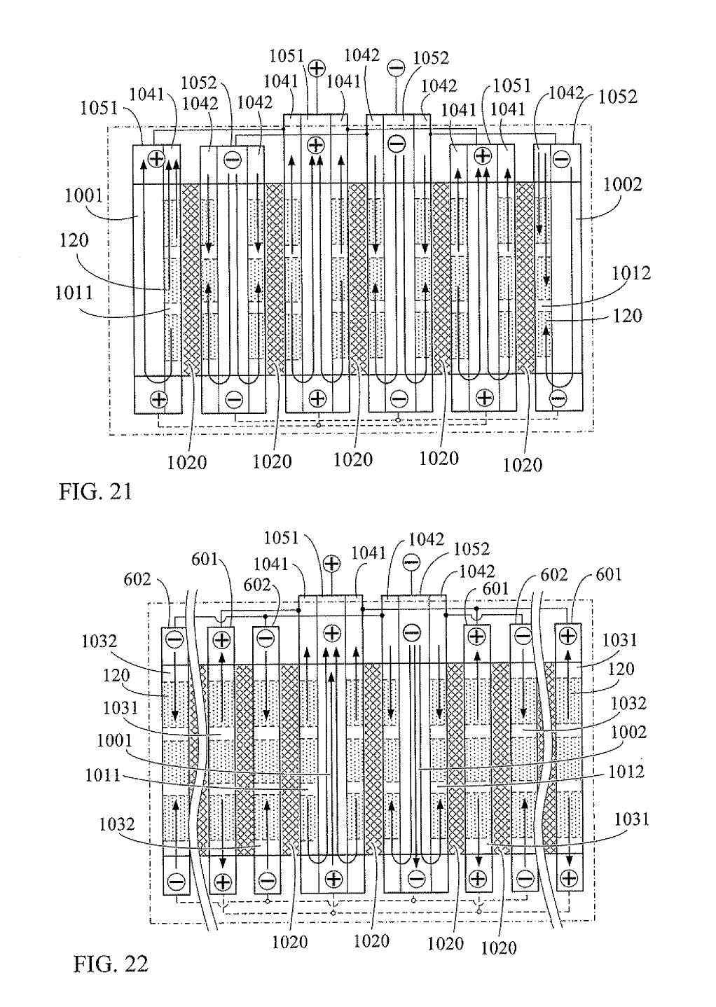

Another structural mode of the present invention is shown as FIG. 21, which is a schematic view showing the third embodiment of combination of negative electrode units and positive electrode units for staggered placement, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current; in which, the positive electrode unit placed at one lateral is constituted by the anode low resistance conductor 1001 placed at lateral clipping with the anode side electrode plate 1011 coated with the active substance 120 on the surface of the electrode plate at the intermediate section thereof, and the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit at lateral;
the negative electrode unit placed at another lateral is constituted by the cathode low resistance conductor 1002 placed at lateral clipping with the cathode side electrode plate 1012 coated with the active substance 120 on the surface of the electrode plate at the intermediate section thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit at lateral; and
two cathode side electrode plates 1012 are coated with the active substance 120 on each electrode plate and at the intermediate section sandwiching the cathode low resistance conductor 1002 at two laterals thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
two anode side electrode plates 1011 are coated with the active substance 120 on each electrode plate and at the intermediate section sandwiching the anode low resistance conductor 1001 at two laterals thereof, and the anode current collecting terminals 1041 placed at two sides of each of two anode side electrode plate1 1011 connect with the anode input/output general current collecting terminals 1051 placed at two sides of the anode low resistance conductor 1001 to constitute the positive electrode unit; and
the above negative electrode units and positive electrode units are staggered placement for constituting the electrode pairs, the negative electrode unit and the positive electrode unit, placed at two laterals, are placed in the electrode tank 1030, and the isolated body 1020 is installed between the positive and negative electrode units, which are staggered placement, in which: the anode input/output general current collecting terminal 1051 of each positive electrode unit coated with the active substance 120 on the electrode plate is unilateral or multilateral connected with same polarity, the cathode input/output general current collecting terminal 1052 of each negative electrode unit is unilateral or multilateral connected with same polarity, and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

The present invention is further shown as FIG. 22, which is a schematic view showing the combination of the electrode pair constituted by at least one positive electrode unit and at least one negative electrode unit, in which the polarities of two laterals, the monolithic positive polarity electrode plate, and the monolithic negative polarity electrode plate are staggered superposition, and the anode input/output general current collecting terminal 1051 of the positive electrode unit and the cathode input/output general current collecting terminal 1052 of the negative electrode unit, placed at intermediate portion, are used to be the general current collecting terminals for inputting/outputting current; in which:
at least one negative electrode unit is constituted by two cathode side electrode plates 1012 coated with the active substance 120 on the surface of each electrode plate and at the intermediate section sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
at least one positive electrode unit is constituted by two anode side electrode plates 1011 coated with the active substance 120 on the surface of each electrode plates and at the intermediate section sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
the negative electrode unit and the positive electrode unit are respectively staggered with one or more monolithic electrode plate units and placed in the electrode tank 1030, in which, the monolithic anode electrode plate 1031 and the monolithic cathode electrode plate 1032 are coated with the active substance 120 on the electrode plates, and are staggered placed at two laterals of the positive electrode unit and the negative electrode unit by polarity; the isolated bodies 1020 are installed between the positive electrode unit, the negative electrode unit, the monolithic anode electrode plate 1031, and the monolithic cathode electrode plate 1032, respectively; the anode input/output general current collecting terminals 1051 of the positive electrode units, and the current collecting terminals 601 of the monolithic anode electrode plate 1031 are used for unilateral or multilateral parallel connecting the same polarity ones; the cathode input/output general current collecting terminals 1052 of the negative electrode units, and the current collecting terminal 602 of the monolithic cathode electrode plate 1032 are used for unilateral or multilateral parallel connecting the same polarity ones; and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

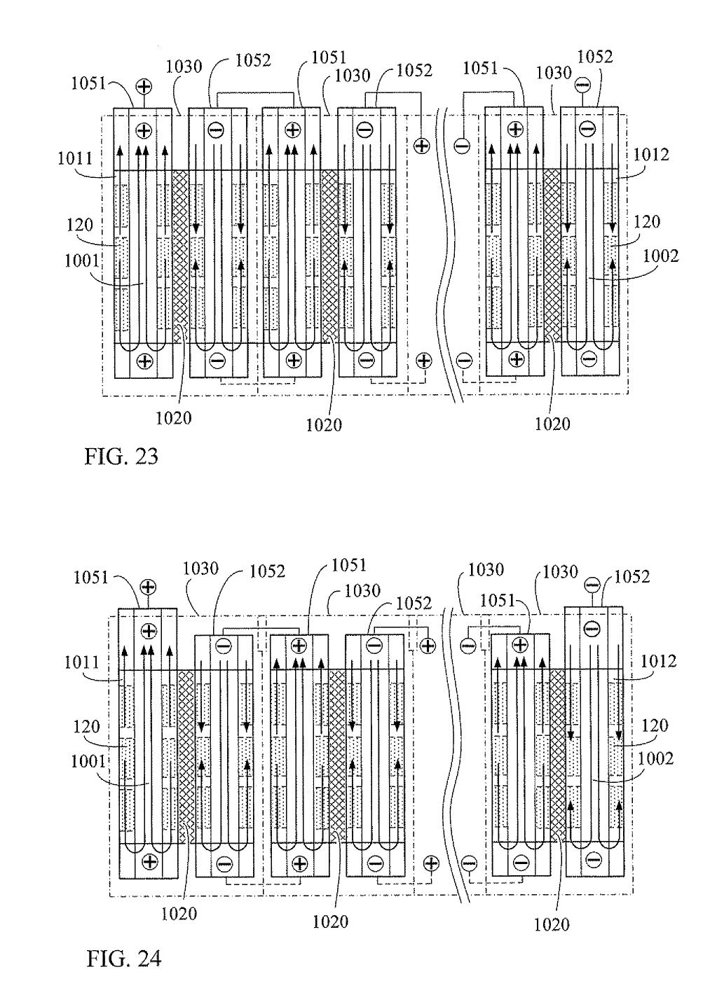

The present invention is further shown as FIG. 23, which is a schematic view showing an embodiment of combination, in which a number of electrode pairs constituted by positive-negative electrode units placed in individual electrode tank 1030 are unilateral or multilateral connected in series by different polarity; in which:
at least two negative electrode units are constituted by two cathode side electrode plates 1012 coated with the active substance 120 on the surface of each electrode plate and at the intermediate section sandwiching the cathode low resistance conductor 1002; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
at least two positive electrode units are constituted by two anode side electrode plates 1011 coated with the active substance 120 on the surface of each electrode plates and at the intermediate section sandwiching the anode low resistance conductor 1001; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least one or more negative electrode units and at least one or more positive electrode units are staggered placed for constituting the electrode pairs, and the isolated bodies 1020 are installed between each electrode unit for being placed in the same electrode tank 1030; if there are more than one electrode units with same polarity placed in the same electrode tank 1030, the current collecting terminals of the electrode units with same polarity are mutually unilateral or multilateral parallel connected; in which, the anode input/output general current collecting terminal 1051 of the positive electrode unit and the cathode input/output general current collecting terminal 1052 of the negative electrode unit, which constitute the electrode pair in each electrode tank 1030, are exposed to the outside of the tank shell of the electrode tank 1030, for unilateral or multilateral connection in series with the electrode pair in different electrode tank 1030 by different polarity; in different electrode tanks 1030, the anode input/output general current collecting terminal 1051 of the positive electrode unit and the cathode input/output general current collecting terminal 1052 of the negative electrode unit in the electrode pair after connected in series are used to be the anode and cathode general current collecting terminals for inputting/outputting current after the connected in series.

FIG. 24 is a schematic view showing the second embodiment of combination shown in FIG. 23, in which except for the anode input/output general current collecting terminal and the cathode input/output general current collecting terminal, which are used to input/output current, are exposed to the outside of the tank shell of the electrode tank 1030, the other current collecting terminals are hidden within the electrode tank 1030.

As shown in FIG. 24, except for the anode input/output general current collecting terminal and the cathode input/output general current collecting terminal, which are used to input/output current, are exposed to the outside of the tank shell of the electrode tank 1030, the other current collecting terminals are hidden within the electrode tank 1030, and the other compositions are same as that of FIG. 23.

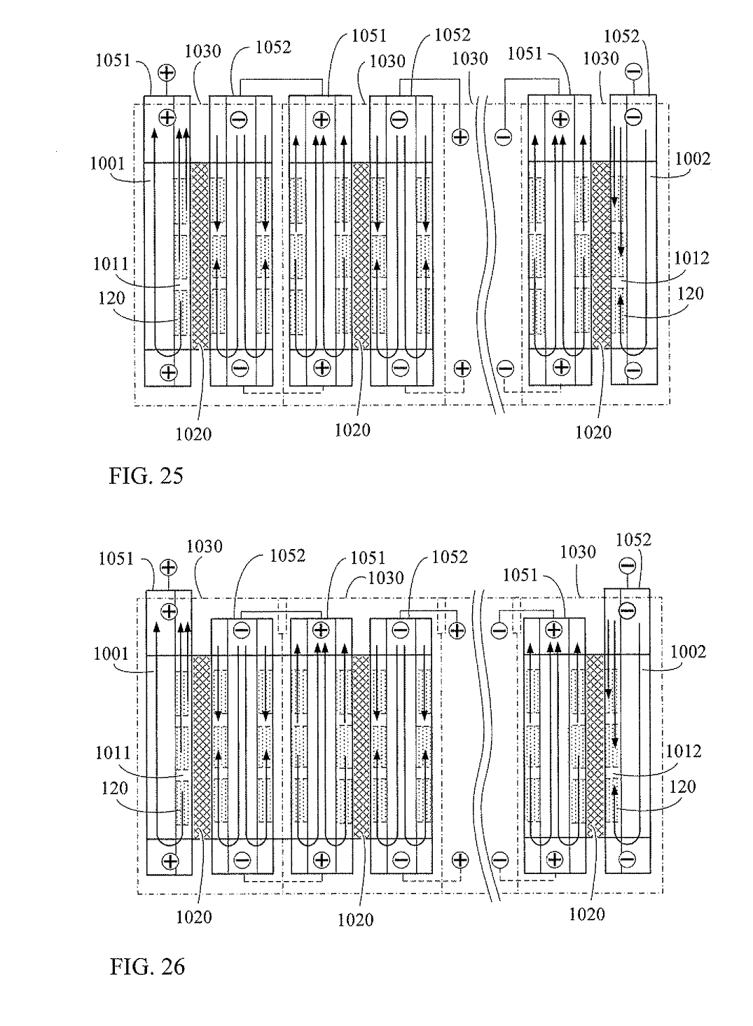

FIG. 25 is a schematic view showing an embodiment of combination, in which a number of electrode pairs constituted by positive-negative electrode units placed at individual electrode tank 1030 are unilateral or multilateral connected in series by different polarity.

As shown in FIG. 25, the positive electrode unit in the electrode tank 1030 for inputting/outing the anode current after connected in series is constituted by the anode low resistance conductor 1001 placed at the lateral sandwiching the anode side electrode plate 1011 at the intermediate section thereof, and the anode current collecting terminals 1041 placed at two sides of the anode side electrode plate 1011 connect with the anode input/output general current collecting terminals 1051 placed at two sides of the anode low resistance conductor 1001 to constitute the positive electrode unit placed at lateral; and
two cathode side electrode plates 1012 coated with the active substance 120 on the surface of each electrode plate at the intermediate section sandwich the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
if there are more than one electrode units with same polarity placed in the electrode tank 1030, the current collecting terminals of the electrode units with same polarity are mutually unilateral or multilateral parallel connected;
also, the negative electrode unit in another electrode tank 1030 for inputting/outing the cathode current after connected in series is constituted by the cathode low resistance conductor 1002 placed at the lateral sandwiching the cathode side electrode plate 1012 coated with the active substance 120 on the surface of the electrode plate at the intermediate section thereof, and cathode current collecting terminal 1042 placed at two sides of the cathode side electrode plate 1012 connect with the cathode input/output general current collecting terminals 1052 placed at two sides of the cathode low resistance conductor 1002 to constitute the negative electrode unit placed at lateral;
two anode side electrode plates 1011 coated with the active substance 120 on the surface of each electrode plate at the intermediate section sandwich the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit;
if there are more than one electrode units with same polarity placed in the electrode tank 1030, the current collecting terminals of the electrode units with same polarity are mutually unilateral or multilateral parallel connected;
at least one or more negative electrode units and at least one or more positive electrode units are staggered placed for constituting the electrode pairs placed in the individual electrode tank 1030 connected in series, and the isolated bodies 1020 are installed between each electrode unit for being placed in the same electrode tank 1030; if there are more than one electrode units with same polarity placed in the same electrode tank 1030, the current collecting terminals of the electrode units with same polarity are mutually unilateral or multilateral parallel connected; in which:
the anode input/output general current collecting terminal 1051 of the positive electrode unit and the cathode input/output general current collecting terminal 1052 of the negative electrode unit, which constitute the electrode pair in each electrode tank 1030 connected in series, are unilateral or multilateral connected in series with the electrode pair in different electrode tank 1030 by different polarity; in different electrode tanks, the anode input/output general current collecting terminal 1051 of the positive electrode unit and the cathode input/output general current collecting terminal 1052 of the negative electrode unit in the electrode pair 1030 after the connected in series are used to be the anode and cathode general current collecting terminals for inputting/outputting current after the connected in series.

FIG. 26 is a schematic view showing the second embodiment of combination shown in FIG. 25, in which except for the current terminals, which are used to input/output current, are exposed to the outside of the tank shell, the other current collecting terminals are hidden within the electrode tank 1030.

As shown in FIG. 26, except for the anode input/output general current collecting terminal and the cathode input/output general current collecting terminal for inputting/outputting current, are exposed to the outside of the tank shell, the other current collecting terminals are hidden within the electrode tank 1030, and the other compositions are same as that of FIG. 25.

For the electric charging/discharging device with low resistance conductor sandwiched between electrode plates, in practical application, two or more sides of the low resistance conductor are individually placed with one or more current collecting terminals, and unilaterally or bilaterally clip with the electrode plate with same polarity, which is installed with one or more current collecting terminals at two or more sides; the one or more current collecting terminals placed at each of the two or more sides of the both are unilaterally or multilaterally parallel connected for constituting the electrode unit with a variety of geometric shapes; hereby give the following cases described below:

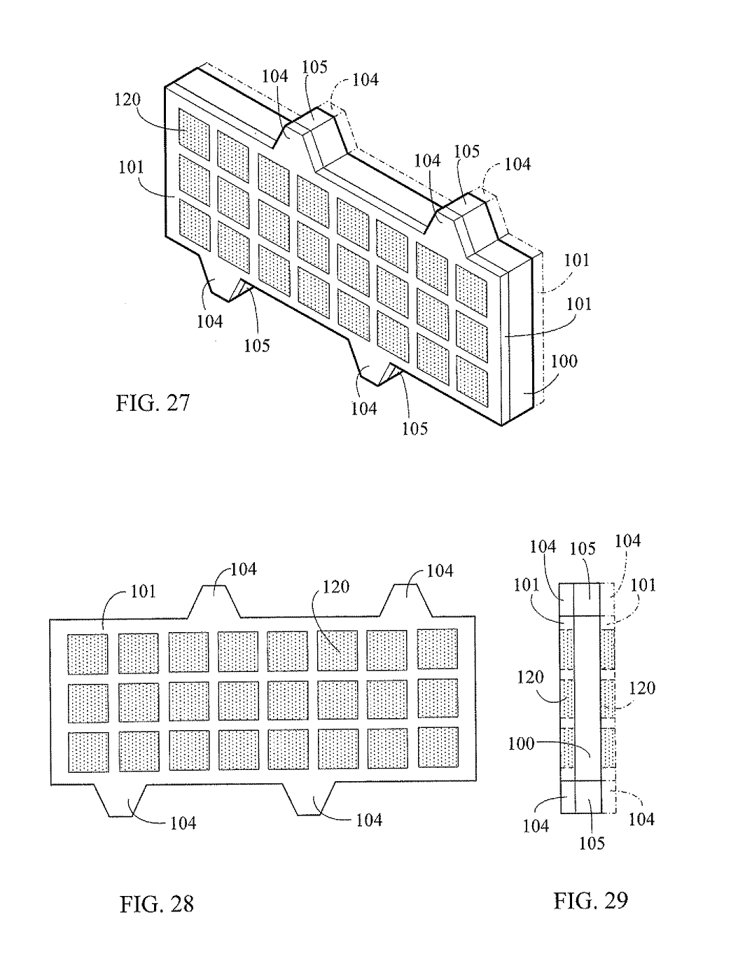

FIG. 27 is a three-dimensional structural schematic view showing the electrode unit constituted by the low resistance conductor, in which two input/output current collecting terminals are installed at each of two sides thereof, clipped by the electrode plate(s) with same polarity, in which two current collecting terminals are installed at each of two sides thereof, at one of two or two outer sides of the low resistance conductor, according to the present invention.

FIG. 28 is a front view of FIG. 27.

FIG. 29 is a side view of FIG. 27.

As shown in FIGS. 27, 28, and 29, the electrode unit constituted by the low resistance conductor, in which two input/output current collecting terminals are installed at each of two sides thereof, clipped by the electrode plate(s) with same polarity, in which two current collecting terminals are installed at each of two sides thereof, at one of two or two outer sides of the low resistance conductor, according to the present invention.

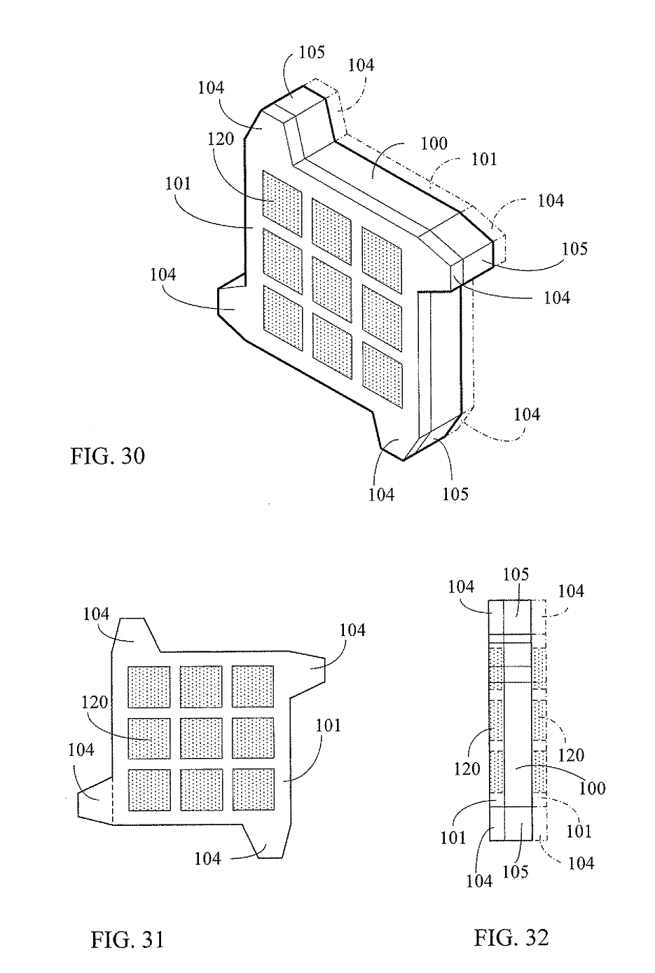

FIG. 30 is a three-dimensional structural schematic view showing the electrode unit constituted by the low resistance conductor, in which a current collecting terminal is installed at each of four sides thereof, clipped by the electrode plate(s) with same polarity, in which a current collecting terminal is installed at each of four sides thereof, at one of two or two outer sides of the low resistance conductor, according to the present invention.

FIG. 31 is a front view of FIG. 30.

FIG. 32 is a side view of FIG. 30.

As shown in FIGS. 30, 31, and 32, the electrode unit constituted by the low resistance conductor, in which a current collecting terminal is installed at each of four sides thereof, clipped by the electrode plate(s) with same polarity, in which a current collecting terminal is installed at each of four sides thereof, at one of two or two outer sides of the low resistance conductor, respectively.

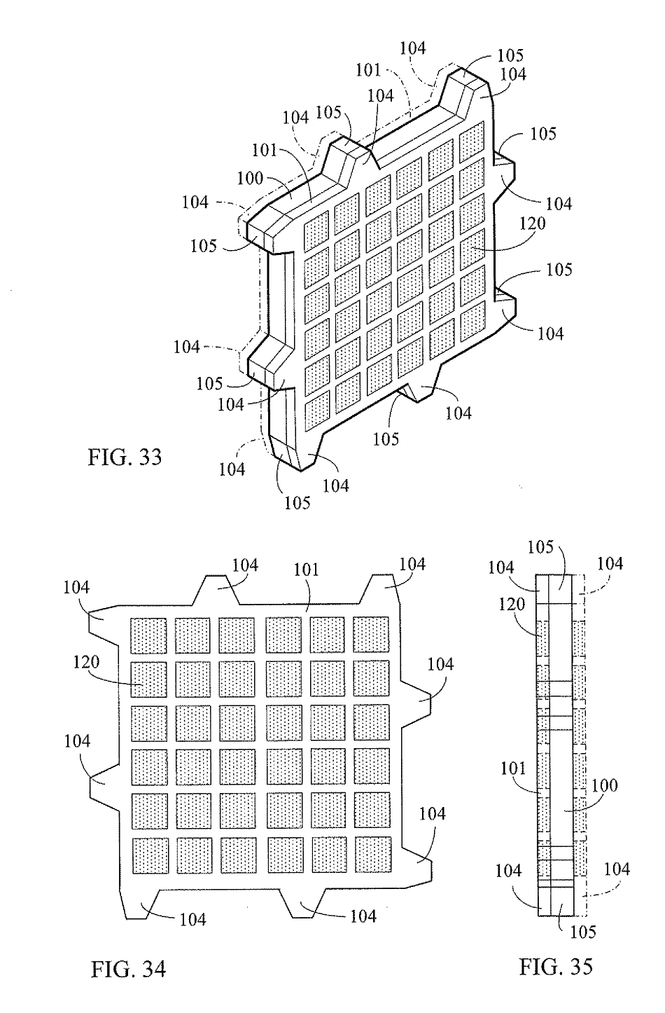

FIG. 33 is a three-dimensional structural schematic view showing the electrode unit constituted by the low resistance conductor, in which two current collecting terminals are installed at each of four sides thereof, clipped by the electrode plate(s) with same polarity, in which two current collecting terminals are installed at each of four sides thereof, at one of two or two outer sides of the low resistance conductor, according to the present invention.

FIG. 34 is a front view of FIG. 33.

FIG. 35 is a side view of FIG. 33.

As shown in FIGS. 33, 34, and 35, the electrode unit constituted by the low resistance conductor, in which two current collecting terminals are installed at each of four sides thereof, clipped by the electrode plate(s) with same polarity, in which two current collecting terminals are installed at each of four sides thereof, at one of two or two outer sides of the low resistance conductor.

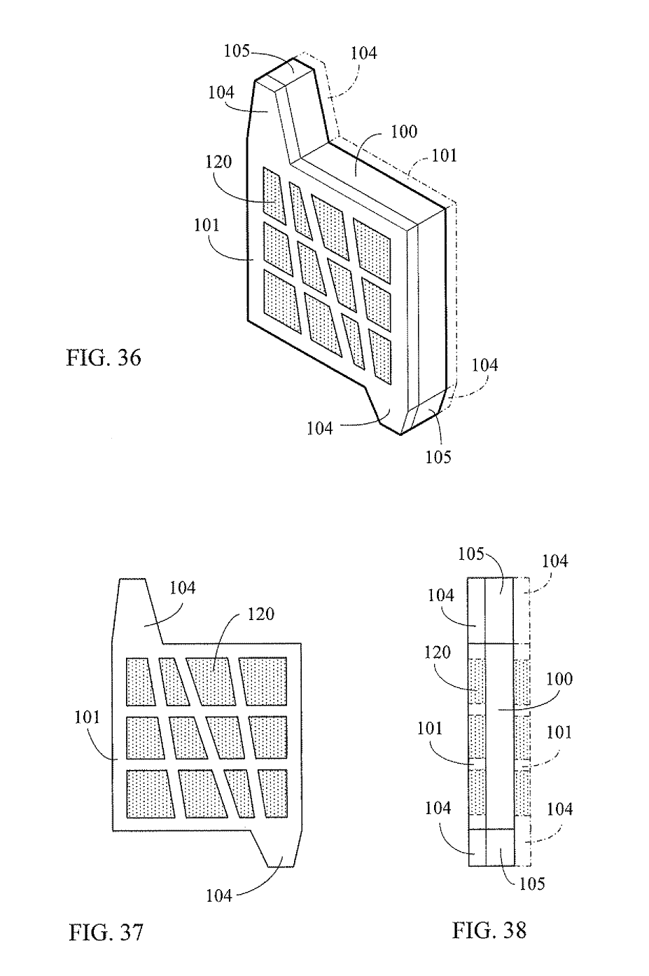

FIG. 36 is a schematic structural view showing an embodiment of application, in which the conductor is radial and the electrode unit is grid layout, according to the present invention.

FIG. 37 is a front view of FIG. 36.

FIG. 38 is a side view of FIG. 36.

As shown in FIGS. 36, 37, and 38, the structure of the electric charging/discharging device with low resistance conductor sandwiched between electrode plates is constituted by a radial conductor and a grid layout electrode unit.

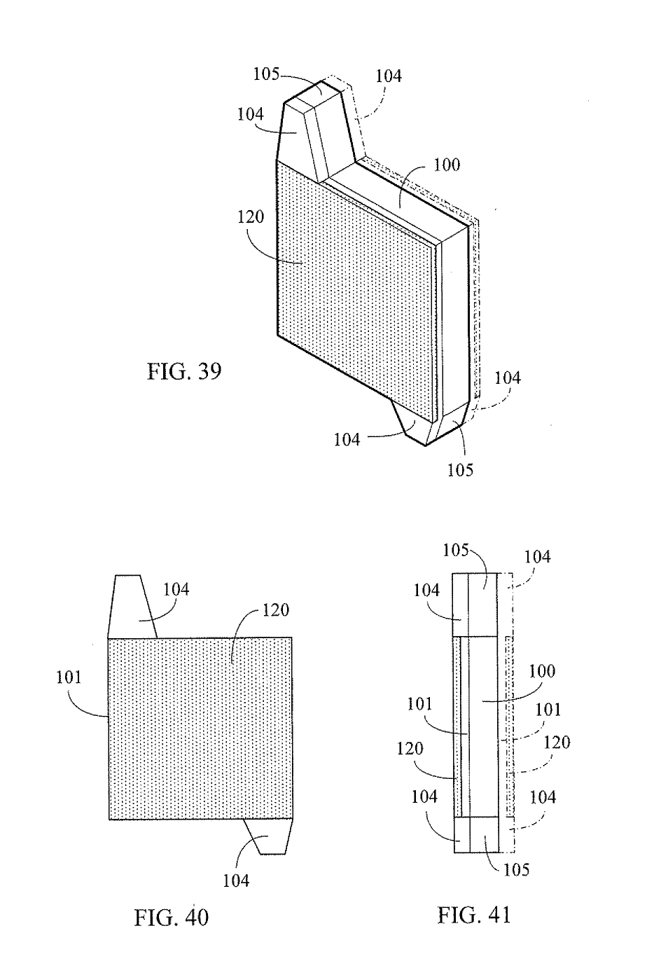

FIG. 39 is a schematic structural view showing an embodiment of application, in which the electrode unit is plate type, according to the present invention.

FIG. 40 is a front view of FIG. 39.

FIG. 41 is a side view of FIG. 39.

As shown in FIGS. 39, 40, and 41, the structure of the electric charging/discharging device with low resistance conductor sandwiched between electrode plates is constituted by a plate type electrode unit.

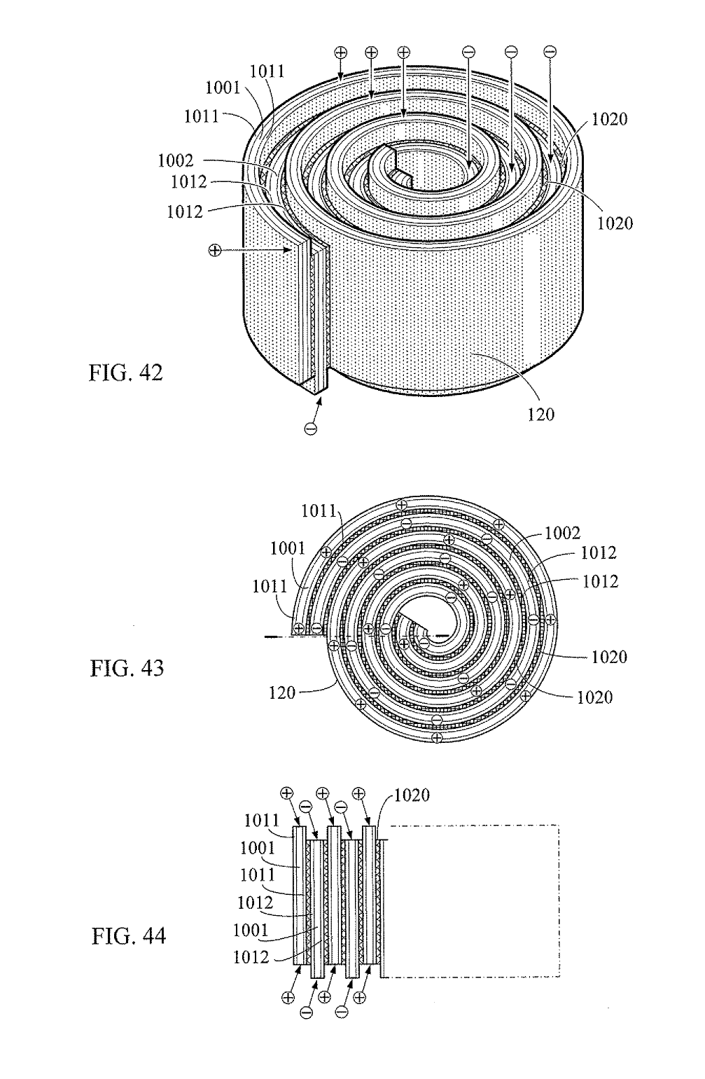

FIG. 42 is a schematic view showing an embodiment of application, in which the electrode unit is used to be a winding type electric charging/discharging device, according to the present invention.

FIG. 43 is a top view of FIG. 42.

FIG. 44 is a side view of FIG. 42.

As shown in FIGS. 42, 43, and 44, the structure of the electric charging/discharging device with low resistance conductor sandwiched between electrode plates is constituted by an electrode unit, which is a winding type electric charging/discharging device.

1. An electric charging/discharging device with low resistance conductor sandwiched between electrode plates, whose mainly structural figure is installed with low resistance conductors, wherein one or more electrode plates, which are installed with at least one current collecting terminal at each of two or more sides thereof, sandwich an low resistance conductor, which is flat shape, strip, or mesh structure, and is made of the material and/or structure with conductivity better than that of the electrode plates; in which at least one current collecting terminal is installed at each of two or more sides of the low resistance conductor, for unilateral or multilateral parallel connecting with the current collecting terminals installed at two or more sides of the electrode plates, and which are used to be the general current collecting terminals to output current to the external part or to receive the input current from the external part; the number of the above general current collecting terminals for inputting/outputting the collection current is one or more; in which the mainly structural figure is installed with a low resistance conductor 100, wherein one or more side electrode plates 101, which are installed with at least one current collecting terminal 104 at two or more sides thereof, and coated with active substance 120 on the surface of the electrode plate, sandwich the low resistance conductor 100, which is flat shape, strip, or mesh structure, and is made of the material and/or structure with conductivity better than that of the electrode plates; in which at least one input/output general current collecting terminal 105 is installed at each of two or more sides of the low resistance conductor 100, for unilateral or multilateral parallel connecting with the current collecting terminals installed at two or more sides of the side electrode plates, and which are used to be the general current collecting terminals to output current to the external part or to receive the input current from the external part, therefore to constitute an electrode unit; the number of the general current collecting terminals 105 for inputting/outputting the collection current is one or more.

2. The electric charging/discharging device with low resistance conductor sandwiched between electrode plates as claimed as claim 1, in which it includes to be applied to the electrode pair of an electric charging/discharging device constituted by two anode electrode plates 1011 sandwiching an anode low resistance conductor 1001 and two cathode electrode plates 1012 sandwiching a cathode low resistance conductor 1002; the mainly structural figure is installed with an anode low resistance conductor 1001, wherein one or more anode side electrode plates 1011, which are installed with at least one anode current collecting terminal 1041 at two or more sides thereof, and coated with the active substance 120 on the surface of the electrode plate, sandwich the anode low resistance conductor 1001, which is flat shape, strip, or mesh structure, and is made of the material and/or structure with conductivity better than that of the electrode plates; in which at least one anode input/output general current collecting terminal 1051 is installed at each of two or more sides of the anode low resistance conductor 1001, for unilateral or multilateral parallel connecting with the anode current collecting terminals installed at two or more sides of the anode side electrode plates, and which are used to be the anode general current collecting terminals to output current to the external part or to receive the input current from the external part, therefore to constitute a positive electrode unit; the number of the anode input/output general current collecting terminal 1051 for inputting/outputting the collection current is one or more;
also, a cathode low resistance conductor 1002 is installed, wherein one or more cathode side electrode plate 1012, which are installed with at least one cathode current collecting terminal 1042 at two or more sides thereof, and coated with the active substance 120 on the surface of the electrode plate, sandwich the cathode low resistance conductor 1002, which is flat shape, strip, or mesh structure, and is made of the material and/or structure with conductivity better than that of the electrode plates; in which at least one cathode input/output general current collecting terminal 1052 is installed at each of two or more sides of the cathode low resistance conductor 1002, for unilateral or multilateral parallel connecting with the cathode current collecting terminals installed at two or more sides of the cathode side electrode plates, and which are used to be the cathode general current collecting terminals to output current to the external part or to receive the input current from the external part, therefore to constitute a negative electrode unit; the number of the cathode input/output general current collecting terminal 1052 for inputting/outputting the collection current is one or more; and
the positive electrode unit and the negative electrode unit mentioned above are installed in a common electrode tank for constituting the electrode pair after combination.

3. The electric charging/discharging device with low resistance conductor sandwiched between electrode plates as claimed as claim 1, in which it includes to be applied to that two negative electrode units sandwich the positive electrode unit at two laterals; wherein:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plate sandwiching the anode low resistance conductor 1001 at two laterals thereof; the anode current collecting terminal 1041 placed at two sides of each of two anode side electrode plates 1011 connect with the anode input/output general current collecting terminals 1051 placed at two sides of the anode low resistance conductor 1001 to constitute the positive electrode unit; the cathode input/output general current collecting terminals 1052 of the two negative electrode units are installed at two sides of the positive electrode unit for unilateral or multilateral parallel connection; and
isolated bodies 1020 are installed between the two sides of the positive electrode unit and the two negative electrode units, respectively; and
the positive electrode unit and the negative electrode unit mentioned above are installed in a common electrode tank for constituting the electrode pair after combination.

4. The electric charging/discharging device with low resistance conductor sandwiched between electrode plates as claimed as claim 1, in which it includes to be applied to that two positive electrode units sandwich the negative electrode unit at two laterals; wherein:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plate sandwiching the anode low resistance conductor 1001 at two laterals thereof; the anode current collecting terminal 1041 placed at two sides of each of two anode side electrode plates 1011 connect with the anode input/output general current collecting terminals 1051 placed at two sides of the anode low resistance conductor 1001 to constitute the positive electrode unit;
the anode input/output general current collecting terminals 1051 of the two positive electrode units installed at two sides of the negative electrode unit are in unilateral or multilateral parallel connection; and
isolated bodies 1020 are installed between the two sides of the negative electrode unit and the two positive electrode units, respectively; and
the positive electrode unit and the negative electrode unit mentioned above are installed in a common electrode tank for constituting the electrode pair after combination.

5. The electric charging/discharging device with low resistance conductor sandwiched between electrode plates as claimed as claim 1, in which it includes to be applied to that two negative electrode units sandwich the positive electrode unit at two laterals; wherein:
the negative electrode unit is constituted by one cathode side electrode plate 1012 coated with the active substance 120 on the surface of the electrode plate clipping with the cathode low resistance conductor 1002 at one lateral thereof; the cathode current collecting terminals 1042 placed at two sides of the cathode side electrode plate 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plate sandwiching the anode low resistance conductor 1001 at two laterals thereof; the anode current collecting terminal 1041 placed at two sides of each of two anode side electrode plates 1011 connect with the anode input/output general current collecting terminals 1051 placed at two sides of the anode low resistance conductor 1001 to constitute the positive electrode unit;
the cathode input/output general current collecting terminals 1052 of the two negative electrode units installed at two sides of the positive electrode unit are in unilateral or multilateral parallel connection; and
isolated bodies 1020 are installed between the two sides of the positive electrode unit and the two negative electrode units, respectively; and
the positive electrode unit and the negative electrode unit mentioned above are installed in a common electrode tank for constituting the electrode pair after combination.

6. The electric charging/discharging device with low resistance conductor sandwiched between electrode plates as claimed as claim 1, in which it includes to be applied to that two positive electrode units clip with the negative electrode unit at two laterals; wherein:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by one anode side electrode plate 1011 coated with the active substance 120 on the surface of the electrode plate clipping with the anode low resistance conductor 1001 at one lateral thereof; the anode current collecting terminal 1041 placed at two sides of the anode side electrode plates 1011 connect with the anode input/output general current collecting terminals 1051 placed at two sides of the anode low resistance conductor 1001 to constitute the positive electrode unit;
the anode input/output general current collecting terminals 1051 of the two positive electrode units installed at two sides of the negative electrode unit are in unilateral or multilateral parallel connection; and
isolated bodies 1020 are installed between the two sides of the negative electrode unit and the two positive electrode units, respectively; and
the positive electrode unit and the negative electrode unit mentioned above are installed in a common electrode tank for constituting the electrode pair after combination.

7. The electric charging/discharging device with low resistance conductor sandwiched between electrode plates as claimed as claim 1, in which at least two negative electrode units and at least two positive electrode units staggered placed for unilateral or bilateral parallel connecting the same polarity ones in a common electrode tank, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current, according to the present invention; wherein
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plates sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least two negative electrode units and at least two positive electrode units are staggered placed in an electrode tank 1030, in which: the anode input/output general current collecting terminals 1051 of the positive electrode units are used for unilateral or bilateral parallel connecting the same polarity ones, the cathode input/output general current collecting terminals 1052 of the negative electrode units are used for unilateral or bilateral parallel connecting the same polarity ones, and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

8. The electric charging/discharging device with low resistance conductor sandwiched between electrode plates as claimed as claim 1, in which electrode units with same polarity for unilateral or bilateral parallel connection in a common electrode tank, in which the anode input/output general current collecting terminal 1051 of the positive electrode unit and the cathode input/output general current collecting terminal 1052 of the negative electrode unit, placed at two laterals, are used to be the general current collecting terminals for inputting/outputting current; in which: at least two negative electrode units and at least two positive electrode units are staggered placed;
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plates sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least two negative electrode units and at least two positive electrode units are staggered placed in the electrode tank 1030, in which: the anode input/output general current collecting terminals 1051 of the positive electrode units are used for unilateral or bilateral parallel connecting the same polarity ones, the cathode input/output general current collecting terminals 1052 of the negative electrode units are used for unilateral or bilateral parallel connecting the same polarity ones, and the anode input/output general current collecting terminal 1051 of the positive electrode unit and the cathode input/output general current collecting terminal 1052 of the negative electrode unit, placed at two laterals, are used to be the general current collecting terminals for the anodes and cathodes inputting/outputting current.

9. The electric charging/discharging device with low resistance conductor sandwiched between electrode plates as claimed as claim 1, in which at least two negative electrode units and at least two positive electrode units staggered placed, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current; in which:
the negative electrode unit is constituted by two cathode side electrode plates 1012 coated with the active substance 120 on the surface of each electrode plate sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
the positive electrode unit is constituted by two anode side electrode plates 1011 coated with the active substance 120 on the surface of each electrode plates sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least two negative electrode units and at least two positive electrode units are staggered placed in the electrode tank 1030, in which: the anode input/output general current collecting terminals 1051 of the positive electrode units are used for unilateral or bilateral parallel connecting the same polarity ones, the cathode input/output general current collecting terminals 1052 of the negative electrode units are used for unilateral or bilateral parallel connecting the same polarity ones, and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

10. The electric charging/discharging device with low resistance conductor sandwiched between electrode plates as claimed as claim 1, in which electrode pairs constituted by positive and negative electrodes for staggered parallel superposition, in which the positive-negative electrode pair with input/output general current collecting terminals is clipped therein, according to the present invention; in which, the positive electrode unit placed at one lateral is constituted by the anode low resistance conductor 1001 placed at lateral clipping with the anode side electrode plate 1011 coated with the active substance 120 on the surface of the electrode plate at the intermediate section thereof, and the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit at lateral;
the negative electrode unit placed at another lateral is constituted by the cathode low resistance conductor 1002 placed at lateral clipping with the cathode side electrode plate 1012 coated with the active substance 120 on the surface of the electrode plate at the intermediate section thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit at lateral;
two cathode side electrode plates 1012 are coated with the active substance 120 on each electrode plate and sandwiching the cathode low resistance conductor 1002 at two laterals thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
two anode side electrode plates 1011 are coated with the active substance 120 on each electrode plate and sandwiching the anode low resistance conductor 1001 at two laterals thereof, and the anode current collecting terminals 1041 placed at two sides of each of two anode side electrode plate1 1011 connect with the anode input/output general current collecting terminals 1051 placed at two sides of the anode low resistance conductor 1001 to constitute the positive electrode unit; and
the above negative electrode units and positive electrode units are staggered placement for constituting the electrode pairs, the negative electrode unit and the positive electrode unit, placed at two laterals, are placed in the electrode tank 1030, and the isolated body 1020 is installed between the positive and negative electrode units, which are staggered placement, in which: the anode input/output general current collecting terminal 1051 of each positive electrode unit is unilateral or multilateral connected with same polarity, the cathode input/output general current collecting terminal 1052 of each negative electrode unit is unilateral or multilateral connected with same polarity, and the anode input/output general current collecting terminal 1051 of the positive electrode unit and the cathode input/output general current collecting terminal 1052 of the negative electrode unit, placed at intermediate portion, are used to be the general current collecting terminals for inputting/outputting current.

11. The electric charging/discharging device with low resistance conductor sandwiched between electrode plates as claimed as claim 1, in which the negative electrode units and positive electrode units for staggered placement, in which the negative electrode units and positive electrode units for staggered placement, in which the anode input/output general current collecting terminal 1051 of the positive electrode unit and the cathode input/output general current collecting terminal 1052 of the negative electrode unit, placed at two laterals, are used to be the general current collecting terminals for inputting/outputting current; in which, the positive electrode unit placed at lateral is constituted by the anode low resistance conductor 1001 placed at lateral clipping with the anode side electrode plate 1011 coated with the active substance 120 on the surface of the electrode plate at the intermediate section thereof, and the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit at lateral;
the negative electrode unit placed at another lateral is constituted by the cathode low resistance conductor 1002 placed at lateral clipping with the cathode side electrode plate 1012 coated with the active substance 120 on the surface of the electrode plate at the intermediate section thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit at lateral;
two cathode side electrode plates 1012 are coated with the active substance 120 on each electrode plate and at the intermediate section of the side electrode plates 1012 sandwiching the cathode low resistance conductor 1002 at two laterals thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
two anode side electrode plates 1011 are coated with the active substance 120 on each electrode plate and at the intermediate section of the side electrode plates 1011 sandwiching the anode low resistance conductor 1001 at two laterals thereof, and the anode current collecting terminals 1041 placed at two sides of each of two anode side electrode plate1 1011 connect with the anode input/output general current collecting terminals 1051 placed at two sides of the anode low resistance conductor 1001 to constitute the positive electrode unit; and
the above negative electrode units and positive electrode units are staggered placement for constituting the electrode pairs, the negative electrode unit and the positive electrode unit, placed at two laterals, are placed in the electrode tank 1030, and the isolated body 1020 is installed between the positive and negative electrode units, which are staggered placement, in which: the anode input/output general current collecting terminals 1051 placed at two sides of each positive electrode unit coated with the active substance 120 on the electrode plate are unilateral or multilateral connected with same polarity, the cathode input/output general current collecting terminals 1052 placed at two sides of each negative electrode unit are unilateral or multilateral connected with same polarity, and the anode input/output general current collecting terminal 1051 of the positive electrode unit and the cathode input/output general current collecting terminal 1052 of the negative electrode unit, placed at two laterals, are used to be the general current collecting terminals for the anodes and cathodes inputting/outputting current.

12. The electric charging/discharging device with low resistance conductor sandwiched between electrode plates as claimed as claim 1, in which negative electrode units and positive electrode units for staggered placement, in which the anode input/output general current collecting terminal 1051 of the positive electrode unit and the cathode input/output general current collecting terminal 1052 of the negative electrode unit, placed at intermediate portion, are used to be the general current collecting terminals for inputting/outputting current; in which, the positive electrode unit placed at one lateral is constituted by the anode low resistance conductor 1001 placed at lateral clipping with the anode side electrode plate 1011 coated with the active substance 120 on the surface of the electrode plate at the intermediate section thereof, and the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit at lateral;
the negative electrode unit placed at another lateral is constituted by the cathode low resistance conductor 1002 placed at lateral clipping with the cathode side electrode plate 1012 coated with the active substance 120 on the surface of the electrode plate at the intermediate section thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit at lateral;
two cathode side electrode plates 1012 are coated with the active substance 120 on each electrode plate and at the intermediate section sandwiching the cathode low resistance conductor 1002 at two laterals thereof, and the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
two anode side electrode plates 1011 are coated with the active substance 120 on each electrode plate and at the intermediate section sandwiching the anode low resistance conductor 1001 at two laterals thereof, and the anode current collecting terminals 1041 placed at two sides of each of two anode side electrode plate1 1011 connect with the anode input/output general current collecting terminals 1051 placed at two sides of the anode low resistance conductor 1001 to constitute the positive electrode unit; and
the above negative electrode units and positive electrode units are staggered placement for constituting the electrode pairs, the negative electrode unit and the positive electrode unit, placed at two laterals, are placed in the electrode tank 1030, and the isolated body 1020 is installed between the positive and negative electrode units, which are staggered placement, in which: the anode input/output general current collecting terminal 1051 of each positive electrode unit coated with the active substance 120 on the electrode plate is unilateral or multilateral connected with same polarity, the cathode input/output general current collecting terminal 1052 of each negative electrode unit is unilateral or multilateral connected with same polarity, and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

13. The electric charging/discharging device with low resistance conductor sandwiched between electrode plates as claimed as claim 1, in which the electrode pair constituted by at least one positive electrode unit and at least one negative electrode unit, in which the polarities of two laterals, the monolithic positive polarity electrode plate, and the monolithic negative polarity electrode plate are staggered superposition, and the anode input/output general current collecting terminal 1051 of the positive electrode unit and the cathode input/output general current collecting terminal 1052 of the negative electrode unit, placed at intermediate portion, are used to be the general current collecting terminals for inputting/outputting current; in which:
at least one negative electrode unit is constituted by two cathode side electrode plates 1012 coated with the active substance 120 on the surface of each electrode plate and at the intermediate section sandwiching the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
at least one positive electrode unit is constituted by two anode side electrode plates 1011 coated with the active substance 120 on the surface of each electrode plates and at the intermediate section sandwiching the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
the negative electrode unit and the positive electrode unit are respectively staggered with one or more monolithic electrode plate units and placed in the electrode tank 1030, in which, the monolithic anode electrode plate 1031 and the monolithic cathode electrode plate 1032 are coated with the active substance 120 on the electrode plates, and are staggered placed at two laterals of the positive electrode unit and the negative electrode unit by polarity; the isolated bodies 1020 are installed between the positive electrode unit, the negative electrode unit, the monolithic anode electrode plate 1031, and the monolithic cathode electrode plate 1032, respectively; the anode input/output general current collecting terminals 1051 of the positive electrode units, and the current collecting terminals 601 of the monolithic anode electrode plate 1031 are used for unilateral or multilateral parallel connecting the same polarity ones; the cathode input/output general current collecting terminals 1052 of the negative electrode units, and the current collecting terminal 602 of the monolithic cathode electrode plate 1032 are used for unilateral or multilateral parallel connecting the same polarity ones; and the anode input/output general current collecting terminal 1051 of the positive electrode unit and the cathode input/output general current collecting terminal 1052 of the negative electrode unit, placed at intermediate portion, are used to be the general current collecting terminals for the anodes and cathodes inputting/outputting current.

14. The electric charging/discharging device with low resistance conductor sandwiched between electrode plates as claimed as claim 1, in which a number of electrode pairs constituted by positive-negative electrode units placed in individual electrode tank 1030 are unilateral or multilateral connected in series by different polarity; in which:
at least two negative electrode units are constituted by two cathode side electrode plates 1012 coated with the active substance 120 on the surface of each electrode plate and at the intermediate section sandwiching the cathode low resistance conductor 1002; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
at least two positive electrode units are constituted by two anode side electrode plates 1011 coated with the active substance 120 on the surface of each electrode plates and at the intermediate section sandwiching the anode low resistance conductor 1001; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit; and
at least one or more negative electrode units and at least one or more positive electrode units are staggered placed for constituting the electrode pairs, and the isolated bodies 1020 are installed between each electrode unit for being placed in the same electrode tank 1030; if there are more than one electrode units with same polarity placed in the same electrode tank 1030, the current collecting terminals of the electrode units with same polarity are mutually unilateral or multilateral parallel connected; in which, the anode input/output general current collecting terminal 1051 of the positive electrode unit and the cathode input/output general current collecting terminal 1052 of the negative electrode unit, which constitute the electrode pair in each electrode tank 1030, are exposed to the outside of the tank shell of the electrode tank 1030, for unilateral or multilateral connection in series with the electrode pair in different electrode tank 1030 by different polarity; in different electrode tanks 1030, the anode input/output general current collecting terminal 1051 of the positive electrode unit and the cathode input/output general current collecting terminal 1052 of the negative electrode unit in the electrode pair after connected in series are used to be the anode and cathode general current collecting terminals for inputting/outputting current after the connected in series.

15. The electric charging/discharging device with low resistance conductor sandwiched between electrode plates as claimed as claim 14, in which except for the anode input/output general current collecting terminal and the cathode input/output general current collecting terminal, which are used to input/output current, are exposed to the outside of the tank shell of the electrode tank 1030, the other current collecting terminals are hidden within the electrode tank 1030, and the other compositions are same as that of claim 14.

16. The electric charging/discharging device with low resistance conductor sandwiched between electrode plates as claimed as claim 1, in which a number of electrode pairs constituted by positive-negative electrode units placed at individual electrode tank 1030 are unilateral or multilateral connected in series by different polarity; wherein, the positive electrode unit in the electrode tank 1030 for inputting/outing the anode current after connected in series is constituted by the anode low resistance conductor 1001 placed at the lateral sandwiching the anode side electrode plate 1011 at the intermediate section thereof, and the anode current collecting terminals 1041 placed at two sides of the anode side electrode plate 1011 connect with the anode input/output general current collecting terminals 1051 placed at two sides of the anode low resistance conductor 1001 to constitute the positive electrode unit placed at lateral;
two cathode side electrode plates 1012 coated with the active substance 120 on the surface of each electrode plate at the intermediate section sandwich the cathode low resistance conductor 1002 at two laterals thereof; the cathode current collecting terminals 1042 placed at two sides of each of two cathode side electrode plates 1012 connect with the cathode input/output general current collecting terminals 1052 placed at two sides of the cathode low resistance conductor 1002 to constitute the negative electrode unit;
if there are more than one electrode units with same polarity placed in the electrode tank 1030, the current collecting terminals of the electrode units with same polarity are mutually unilateral or multilateral parallel connected;
also, the negative electrode unit in another electrode tank 1030 for inputting/outing the cathode current after connected in series is constituted by the cathode low resistance conductor 1002 placed at the lateral sandwiching the cathode side electrode plate 1012 coated with the active substance 120 on the surface of the electrode plate at the intermediate section thereof, and cathode current collecting terminal 1042 placed at two sides of the cathode side electrode plate 1012 connect with the cathode input/output general current collecting terminals 1052 placed at two sides of the cathode low resistance conductor 1002 to constitute the negative electrode unit placed at lateral;
two anode side electrode plates 1011 coated with the active substance 120 on the surface of each electrode plate at the intermediate section sandwich the anode low resistance conductor 1001 at two laterals thereof; the anode current collecting terminals 1041 placed at two sides of each of two anode side electrode plates 1011 connect with the anode input/output general current collecting terminals 1051 placed at two sides of the anode low resistance conductor 1001 to constitute the positive electrode unit;
if there are more than one electrode units with same polarity placed in the electrode tank 1030, the current collecting terminals of the electrode units with same polarity are mutually unilateral or multilateral parallel connected;
at least one or more negative electrode units and at least one or more positive electrode units are staggered placed for constituting the electrode pairs placed in the individual electrode tank 1030 connected in series, and the isolated bodies 1020 are installed between each electrode unit for being placed in the same electrode tank 1030; if there are more than one electrode units with same polarity placed in the same electrode tank 1030, the current collecting terminals of the electrode units with same polarity are mutually unilateral or multilateral parallel connected; in which:
the anode input/output general current collecting terminal 1051 of the positive electrode unit and the cathode input/output general current collecting terminal 1052 of the negative electrode unit, which constitute the electrode pair in each electrode tank 1030 connected in series, are unilateral or multilateral connected in series with the electrode pair in different electrode tank 1030 by different polarity;
in different electrode tanks, the anode input/output general current collecting terminal 1051 of the positive electrode unit and the cathode input/output general current collecting terminal 1052 of the negative electrode unit in the electrode pair 1030 after the connected in series are used to be the anode and cathode general current collecting terminals for inputting/outputting current after the connected in series.

17. The electric charging/discharging device with low resistance conductor sandwiched between electrode plates as claimed as claim 16, in which except for the anode input/output general current collecting terminal and the cathode input/output general current collecting terminal for inputting/outputting current, are exposed to the outside of the tank shell, the other current collecting terminals are hidden within the electrode tank 1030, and the other compositions are same as that of claim 16.

18. The electric charging/discharging device with low resistance conductor sandwiched between electrode plates as claimed as claim 1, in which the electrode unit constituted by the low resistance conductor, in which an input/output current collecting terminal is installed at each of two sides thereof, clipped by the electrode plate(s) with same polarity, in which a current collecting terminal is installed at each of two sides thereof, at one of two or two outer sides of the low resistance conductor.

19. The electric charging/discharging device with low resistance conductor sandwiched between electrode plates as claimed as claim 1, in which two input/output current collecting terminals are installed at each of two sides thereof, clipped by the electrode plate(s) with same polarity, in which two current collecting terminals are installed at each of two sides thereof, at one of two or two outer sides of the low resistance conductor.

20. The electric charging/discharging device with low resistance conductor sandwiched between electrode plates as claimed as claim 1, in which a current collecting terminal is installed at each of four sides thereof, clipped by the electrode plate(s) with same polarity, in which a current collecting terminal is installed at each of four sides thereof, at one of two or two outer sides of the low resistance conductor.

21. The electric charging/discharging device with low resistance conductor sandwiched between electrode plates as claimed as claim 1, in which a current collecting terminal is installed at each of four sides thereof, clipped by the electrode plate(s) with same polarity, in which a current collecting terminal is installed at each of four sides thereof, at one of two or two outer sides of the low resistance conductor.

22. The electric charging/discharging device with low resistance conductor sandwiched between electrode plates as claimed as claim 1, in which the structure of the electric charging/discharging device with low resistance conductor sandwiched between electrode plates is constituted by a radial conductor and a grid layout electrode unit.

23. The electric charging/discharging device with low resistance conductor sandwiched between electrode plates as claimed as claim 1, in which the structure of the electric charging/discharging device with low resistance conductor sandwiched between electrode plates is further constituted by a plate type electrode unit.

24. The electric charging/discharging device with low resistance conductor sandwiched between electrode plates as claimed as claim 1, in which the structure of the electric charging/discharging device with low resistance conductor sandwiched between electrode plates is constituted by an electrode unit, which is a winding type electric charging/discharging device.

25. The electric charging/discharging device with low resistance conductor sandwiched between electrode plates as claimed as claim 1, which is applied to the electric charging/discharging device, such as primary batteries, rechargeable batteries, capacitors, or super capacitors, or to the positive-negative electrode pair required for the fuel cell with electrode plate(s).
